(19) United States
(12) Patent Application Publication
(10) Pub. No.: US 2020/0172839 A1
(43) Pub. Date: Jun. 4, 2020

(54) METHOD OF IMPROVING FLAVOR STABILITY IN FERMENTED BEVERAGES

(71) Applicant: COORS BREWING COMPANY, Denver, CO (US)

(72) Inventors: Robert T. Foster, II, Golden, CO (US); Warren R. Quilliam, Arvada, CO (US); Jay R. Refling, Greenfield, WI (US); Susan B. Kay, Wauwatosa, WI (US); Anthony Manuele, Centennial, CO (US)

(21) Appl. No.: 16/623,997

(22) PCT Filed: Jun. 12, 2018
(86) PCT No.: PCT/US18/37052

§ 371 Date: Dec. 18, 2019

Related U.S. Application Data
(60) Provisional application No. 62/521,853, filed on Jun. 19, 2017.

(51) Int. Cl. C12C 11/06; C12C 1/16; C12C 7/28

(52) U.S. Cl. CPC C12C 11/06; C12C 7/287; C12C 1/16

(57) ABSTRACT

Compositions and methods are disclosed for stabilizing the flavor of a fermented beverage, most particularly beer, by the addition of a composition comprising a tannin and a solid carrier prior to, or during early stages of, fermentation of the beverage. The invention is also directed to the fermented beverage prepared by such a method. The composition may include at least one polyphenol therein and may be in the form of a pellet.

### CROSS-REFERENCE TO RELATED APPLICATIONS

This application claims priority from U.S. Patent Application No. 62/521,853 filed Jun. 19, 2017.

### STATEMENT REGARDING FEDERALLY-SPONSORED RESEARCH OR DEVELOPMENT

Not Applicable.

### FIELD OF THE INVENTION

This invention provides a composition and methods for stabilizing the flavor of a fermented beverage, most particularly beer, by the addition of a composition comprising a tannin and a solid carrier prior to fermentation. The invention is also directed to the fermented beverage prepared by such a method.

### BACKGROUND OF THE INVENTION

### I. The Brewing Process

Fermented malt beverages, such as beer, are produced by boiling a warm water extract of malted barley, with or without other unmalted grains such as rice or corn, with hops, solids filtration, cooling, and then subjecting the resulting liquor to the fermentative action of yeast. The warm water used to extract the malt allows the action of several enzymes in the malt to hydrolyze the starch in the malted barley (and in the corn or rice adjunct starch) to fermentable sugars, which are acted on by the yeast to produce alcohol in the fermented malt beverage.

Barley malt is steeped with water to produce steeped out barley, which is germinated at a fairly low temperature. Germination is carried out with daily mixing and watering as needed to reach a moisture content about 43%. The resulting green malt contains a high content of beer flavor precursors, beer flavor components and coloring compounds. After germination is complete, the green malt is heated at a high moisture content to generate beer flavor precursors, beer flavor components, develop the desired color and also to reduce amylitic enzyme activity. After heating, the malt is dried to a moisture content of 3.5-5.5% and a soluble protein content of 6.5-8%. The dried malt can then be mashed and solids filtered to produce a wort. The wort is then boiled with hops, cooled, pitched with brewers yeast, and processed by conventional brewing processes using conventional brewing equipment.

The malt bill, which may actually be a blend of malts (i.e., standard brewer's malt, high color, low amylase malt, specialty malts, etc.), is ground and mixed with 2.5 to 4 times its weight of warm water in large tubs and mashed at 35-40° C. for 5 to 15 minutes until it forms a thick malt mash. The mash is then permitted to rest for 45-90 minutes without stirring, then heated in steps to 70-73° C. while stirring, with time allowed at each step for the various enzymes to convert the starches into fermentable sugars. Following heating, the mash is held for 15-30 minutes for complete conversion of the starches to sugars, the temperature is raised to 75° C., and the mash is transferred to the lauter unit or a mash filter.

If rice and corn adjuncts are to be used, they are separately cooked and a cooker mash is obtained. Production of the cooker mash involves the use of adjuncts along with a 10%-30% portion of the malt (or the addition of commercial enzymes) to convert raw starch into fermentable sugars. The adjuncts and the malt portion are gradually brought to boiling and held there until the products are completely gelatinized. During the final stages of mashing (at the higher temperatures), the cooker mash and the malt mash are combined in an infusion or decoction process for complete starch conversion to sugar.

Mashing serves three purposes. First, it brings into solution those substances of malt (and adjuncts) which are readily soluble in warm water. Second, it permits malt enzymes to act on insoluble substances and render them soluble. Third, it provides a far-reaching enzymatic degradation of starches, proteins and gums into products of smaller size and lower molecular weight to ultimately produce beer.

Lautering and Sparging. Lautering or mash filtration consists of the removal of the liquid, now termed the “wort,” from the insoluble husks or “spent grains.” Separation of liquid from solids through filtration begins upon termination of the mashing process, whereby the finished mash is transferred to a lautering tub or through a mash filter. There it is allowed to rest for about ten to thirty minutes during which time the spent grains settle to the bottom or to a horizontal plate and frame filter carpet. The lautering tub is equipped with a false bottom containing numerous perforations and an outlet leading to the true bottom of the tub. The mash filter is a horizontal closed system that traps the solids and passes the wort liquid forward. The mash is then allowed to settle for 10-20 minutes and run-off begun. The wort is recycled until reasonably clear. The clear wort is then pumped into a brewing kettle. The hot wort in the mash filter is run directly to the brew kettle. In both systems, this is termed “first wort”. Hot water is run through the spent grains in both systems to rinse out, or sparge, any remaining wort sugars. The lauter and mash filter temperature is about 72-77° C. for both the first wort and sparge water. The amount of sparge water used is about 50-75% of the amount of brewing water to achieve the target sugar gravity.

Boiling and Hopping of Wort. The wort is boiled vigorously for 1-2.5 hours in the brew kettle. Hops (or extracts thereof) may be added at various stages of the boiling process, depending on the nature of the final product that is sought. Hops provide aroma and flavor, bitterness, foam and anti-microbial activity to fermented malt beverages. Hops can be extracted by supercritical/liquid CO₂ or organic solvents to produce hop extracts and remaining hop solid resins. Hop extracts are commercially available. The hop extract includes alpha-acids, beta-acids, and hop oil fraction of the hop. The alpha-acids are converted into iso-alpha-acids during wort boiling to contribute bitterness to fermented malt beverages. The hop oil fraction provides some aroma to fermented malt beverages. U.S. Pat. Nos. 5,783,235 and 5,972,411 report the application of the remaining hop solids for flavoring of the fermented malt beverages.

Wort boiling provides a concentration of the sparged wort, complete inactivation of enzymes that may have survived the final mashing process, coagulation and precipitation of high-molecular weight proteins and solids (termed “kettle break” or “hot break”), extraction of desirable hop constituents and sterilization of the wort.

Cooling, Fermentation and Storage: Maturation. After boiling, the wort is strained or spent through centrifugal action to remove the kettle break solids, or “trub,” and the wort is then cooled to a temperature of about 12-16° C. Fermentation is initiated when the wort is pitched with the proper amount of a pure brewer's yeast culture (typically about 0.7-1.5 lb/bbl). After 24 hours, fermentation is established and proceeds at an accelerated rate. Fermentation typically proceeds for about 7 to 10 days. During this period, the wort temperature must be controlled, since the fermentation process causes the temperature of the wort to rise. Once the yeast has metabolized all the fermentable ingredients in the wort, it settles to the bottom and is subsequently recovered and recycled for use in pitching subsequent brews. As the fermentation process comes to a conclusion, the temperature of the wort begins to drop. The fermented wort (termed “green beer”) is drawn off for storage in a cold room tank, or “ruh,” where, its temperature is lowered to about 0-5° C.

Processing and Packaging. The “ruh” beer may be allowed to remain in the ruh tank for completion of the maturation process, or it may be transferred into a separate maturation tank upon further settling of any remaining yeast and other solids. Depending on the particular brewery, the beer is allowed to age from about 14 days to about 3 months. During this period, the beer clarifies and its flavor develops. Upon maturation, the beer generally is filtered to remove the yeasts and other solids.

The beer can undergo a single- or a double-pass filtration process. The double-pass filtration includes two steps: a primary (coarse) filtration, and a secondary (fine) filtration or can be allowed to settle over time and then centrifuged depending on the brewery. Filtered beer is subsequently stored in a finishing tank.

To prepare the beer for consumption, it is carbonated to a specified level. Then, depending on the form of packaging, the beer may be pasteurized. (In the case of the cold-filtered “draft” beers, a microfiltration system is used to remove contaminants, thereby obviating the pasteurization step.) Beer packaged in cans and bottles may or may not be pasteurized depending on the brand profile, while beer packaged in kegs remains unpasteurized. After final processing of the packaged product (e.g., labeling, etc.), the beer is ready for shipment to the consumer.

Other conventional processing steps well known to those skilled in the art may be used instead of, or in addition to, the above-disclosed general brewing methods. For example, the wort may be treated with enzymes and/or the fermented wort can be diluted with water to produce a low calorie (40 or fewer calories per 12 ounces) beer. Non-alcoholic malt beverage (less than 0.5 volume percent alcohol) that closely simulates conventional beer flavor, taste and mouthfeel may be produced by a number of processes included arrested fermentation, distillation of the beer alcohol, or beer ultrafiltration.

### II. Flavor and Flavor Stability

Malt beverages, especially beer, possess attributes, such as foam, flavor and clarity that are discernable by the consumer. Of course, flavor is a key factor in the quality of a malt beverage. Flavor (purity) and after-taste (refreshing feeling) are typically measured within the industry as having one of the following five grades—1: Taste is not very clean and after-taste has no refreshing feeling. 2: Taste is not clean and after-taste has almost no refreshing feeling. 3: Usual. 4: Taste is clean and after-taste has refreshing feeling. 5: Taste is very clean and after-taste has very refreshing feeling.

Sensory testing has been the traditional means available for assessing the organoleptic quality of beer. The Institute of Brewing Technology began using high performance liquid chromatography (HPLC) analyses according to e.g., Greenhoff and Wheeler, J. Inst. Brew 86:35 (1981); Strating and Drost, Dev. in Food Sci. 17:109-121 (1988). Improved methods utilizing purge and trap techniques, gas chromatography, and mass selective detection using the SIM technique were applied to establish higher capacity and better separation, determination and identification. See, e.g., Narziss et al., MBAR Tech. Q. 30:48-53 (1993). However, objective measurements of a particular quality parameter are meaningless unless they are correlated to the human response to the beverage as a whole when purchased and consumed under normal conditions.

It is important that a beer retains its original, fresh flavor and character during distribution and storage. Thus, off-flavors are a great problem for beer manufacturers and distributors. The lightstruck flavor is a well-known off-flavor formed during the storage of bottled beer, usually in clear or green bottles, as is the obnoxious off-flavor caused by contamination with microorganisms. Other off-flavors that are produced during storage are described as “papery”, “cardboard-like”, “oxidized”, or in general, “stale”. At room temperature, the stale flavor in canned or bottled beer begins to develop shortly after packaging, and gradually and continuously increases to the extent that most American manufacturers of beer recall their product from the market if it is more than about 4 months from the packaging date. Although the oxygen in a bottle or can of beer is typically consumed by the beer within 24 hours of packaging, the noticeable presence of a stale flavor generally does not appear for 2-8 weeks depending on the product.

In the past, the stale flavor of oxidized malt beverages, such as beer, generally has been attributed to the combined effects of oxidation by heat, age, trace metals and light. Most investigators have focused on methods of reducing oxidation in the finished product. For example, the present practice of delaying the staling of beer includes maintaining a low level of air (or oxygen) in the packaged beer by minimizing free head space. Modern beer-filling machines are designed to achieve very low air levels in the packaged product. Typically, the bottle is evacuated before it is filled with beer, or the air in the evacuated bottle is replaced with carbon dioxide before filling, or overfoaming the bottle is utilized to displace the head space gases with beer foam. All of these practices can produce air levels of less than 0.5 ml per 12 oz. bottle. However, even these low levels of air still allow beer to oxidize or stale in 2-3 months.

The rate at which aged or stale off-flavor forms in beer has presented a problem to brewers for many years. The environment in which beer is stored is critical for minimizing staling. If the beer is stored at cooler temperatures, the staling process will only occur slowly; and of course, raising the temperature will increase the rate of staling. However, although beer is ideally stored at cold temperatures, maintaining a uniformly cool temperature is not always possible during transportation. Given the increasing number of international beer brands, distribution distances increase and global demand, the ability to carefully control the storage environment for beer is compromised. This is a particular problem in hot and humid countries where the temperature averages 28-38° C., even more so in those countries where modern refrigeration is not always available. Therefore, the problem of beer flavor staling is ever more evident as brewers strive to assure the quality of their product in the face of increased transportation and storage times in the global market.

Flavor stability is typically evaluated in the stored packaged product (usually at a storage temperature of 28° C. for 15 days) as having one of the following five grades: 1: Significantly stale; 2: Staled; 3: Usual; 4: Fresh; and 5: Very fresh. Traditionally, those wishing to investigate the flavor stability of beer have used human sensory analysis for measuring the off flavors that may develop in beer. However, because oxidative degradation has been found to be one cause of stale flavors in beer, analytical chemical methods have been developed to evaluate the flavor stability of beer by evaluating the oxidation resistance (anti-oxidants) of beer. For instance, U.S. Pat. No. 5,811,305 describes an analytical method for evaluating flavor stability of a fermented alcoholic beverage using electron spin resonance (ESR). By investigating the formation behavior of active oxygen (or free radicals) at the start of oxidative deterioration, it is possible to accurately evaluate and predict the flavor stability of a fermented alcoholic beverage at the time it becomes a finished product.

In the mashing process, enzymes (e.g., lipoxygenase A & B or lipoxygenase) may produce stale aldehydes from unsaturated fatty acids, i.e., UFA, during the malt mash-in period. These aldehydes may ultimately harm the flavor stability of the fermented beverage. For example, lipoxygenase may produce via an auto-oxidation reaction, catalyzed by divalent metals (especially iron and to a lesser extent manganese and copper) and oxygen, creating aldehydes from free radical reactions. In effect, the free radical reactive oxygen species (e.g., superoxide, hydroxyl, peroxy, hydroperoxyl, 1-hydroxyethyl radical, 2-hydroxyethyl radical) may split and oxidize the unsaturated fatty acid molecules into stale aldehydes and stable aldehyde adducts, and, as such, are detrimental to flavor stability. Further, the stale aldehydes and aldehyde adducts may survive boil, fermentation, and ultimately end up in packaged products. As a result, the flavor stability of the fermented beverage is limited and the shelf-life thereof is shortened.

Further, ethanol may also be oxidized by iron (Fe), manganese (Mn) and copper (Cu) to produce the dominant aldehyde, acetaldehyde, which can also be produced by yeast oxidation of pyruvate, and Strecker degradation of amino acids (e.g., α-alanine). As discussed, these stale aldehydes are produced at malt mash-in and are promoted by higher pH, lower mash-in temperatures, divalent metals, and the presence of oxygen.

### III. The Related Art

There have been many attempts to stabilize the flavor of fermented products. For instance, U.S. Pat. No. 6,372,269 describes stabilizing the flavor of beer by adding one or more reductase enzymes from naturally occurring sources to the fermented malt beverage. In U.S. Pat. No. 5,460,836, it is suggested that extracting and removing lipids from malt using subcritical or supercritical carbon dioxide can improve the flavor stability of malt beverages. In U.S. Pat. No. 4,911,936, it is proposed that adding yeast to a fermented beer can stabilize the flavor of malt beverages. U.S. Pat. No. 6,372,269 teaches that yeast cells that produce reductase enzymes can be added to wort during the beer making process to stabilize the flavor of beer. In “Potential Antioxidants in Beer Assessed by ESR Spin Trapping”, J. Agric. Food Chem. 2000, 48, 3106-3111, July 2000, it is reported that sulfite, phenolic compounds, thiols and ascorbic acid were tested as potential antioxidants to stabilize the flavor of beer. These patents and all other patents and publications cited herein are incorporated herein by reference.

Another recognized technique for stabilizing beer against oxidation is to add an antioxidant such as sulfur dioxide, predominately in the bisulfite form at beer pH, to the beer. Sulfite is known to have anti-oxidative activity, and has been widely used as an antioxidant in the fields of food, beverage and pharmaceuticals, and also in an alcoholic beverage. Sulfite is known to be an efficient naturally occurring antioxidant in beer and various examples of adding sulfite after brewing to improve beer stability are known to the art. Thus, it is known that sulfites can improve the shelf life in beer when added after brewing. However, in the United States, for example, SO₂ is limited by law to less than 10 ppm, and even those low levels produce undesirable and sulfury aromas in some beers. In other countries, such as Germany, any addition of exogenous SO₂ is strictly prohibited.

Further, the effectiveness of antioxidants is greatly reduced when added to the fermentable medium prior to boiling. See, for instance, U.S. Patent Application Publication No. 2004/0161491 which teaches that sulfite antioxidants have little effect in reducing the generation of free radical precursors when added during boiling. Further still, the addition of bisulfite, which works by binding to aldehydes, is not considered to be an ideal solution to stabilizing beer against oxidation. Beer is a complex product, comprising many different aldehydes (notably acetaldehyde, a normal by-product of fermentation), hence the action of a sulfite additive is often muted. The addition of other oxygen scavengers has also been tried, but with little effect on the long-term stability of the flavor in the fermented malt beverage. Adding extra ingredients to improve the stability of beer against oxidation are also known. See, for example, WO 2009/032215, which teaches adding a hydroxytyrosol-rich composition to a beverage (such as beer) after fermentation or storage to prevent undesired oxidation.

In spite of all of the available art and years of research, beer flavor still goes stale. Thus, a need exists for an improved method of stabilizing the flavor of fermented products such as beer.

### SUMMARY OF THE INVENTION

This invention provides compositions and methods for stabilizing the flavor of a fermented beverage made from a fermentable medium by adding a composition comprising a tannin and a solid carrier to the fermentable medium. In particular, the composition comprising the tannin and the solid carrier is added to the fermentable medium prior to fermentation. The invention is also directed to the fermented beverages prepared by such a method.

In one aspect, the invention provides a composition for improving a flavor stability of a fermented beverage produced from a fermentable medium wherein the composition comprises a tannin; and a solid carrier, and wherein the composition is in a form of a pellet.

In one embodiment, a tannin is obtained from a hydrolyzable tannin and, in the preferred embodiment, from a gallotannin. In this embodiment, the tannin is a gallic acid ester formed from glucose and gallic acid.

In one embodiment, the tannin is gallotannin according to the general structure (I).

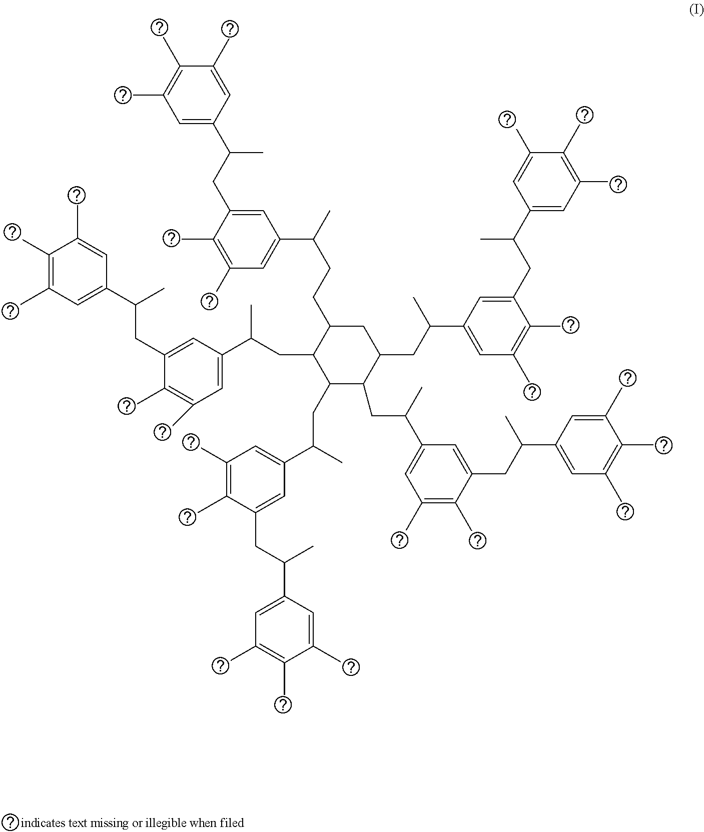

In one embodiment, a solid carrier comprises a hop residue or a solid hop residue. In the preferred embodiment, the solid carrier is a solid hop carrier obtained by extracting hops with carbon dioxide.

In another embodiment, the solid carrier comprises a malt, and in a particular embodiment, a malt powder.

In one embodiment, the solid carrier comprises at least one polyphenol.

In one embodiment, the tannin is in the composition in a range from about 3 weight % to about 20 weight % of the composition and, in a another embodiment, in a range from about 3 weight % to about 12 weight %. In non-limiting example embodiments, the tannin is in the composition in an amount of about 5 weight %, or of about 10 weight %, compared to the total weight of the composition.

In one embodiment, the solid carrier is in the composition in a range from about 80 weight % to about 97 weight % of the composition and, in another embodiment, in a range from about 88 weight % to about 97 weight %. In certain non-limiting example embodiments, the solid carrier is in the composition in an amount of about 90 weight %, or about 95 weight %, compared to the total weight of the composition.

In one embodiment, the composition further comprises water and has a moisture content ranging from about 1% to about 20%. In another embodiment, the composition has a moisture content from about 8% to about 12%. In a non-limiting example embodiment, the composition has a moisture content of about 10%.

In one embodiment, the composition further comprises at least one antioxidative ingredient. Further, in this embodiment, the at least one antioxidative ingredient may be selected from the group consisting of antiradical enzymes, antioxidative amino acids, chelating agents, malt polyphenol fractions, and mixtures thereof.

In an illustrative embodiment, the composition is in the form of a pellet.

In one version of the composition, the tannin is a gallotannin; the solid carrier comprises a solid hop residue obtained by extracting hops with carbon dioxide; the tannin is in the composition in a range from about 3 weight % to about 20 weight % of the composition; and the solid carrier is in the composition in a range from about 80 weight % to about 97 weight % of the composition.

In another aspect, the invention provides a method for improving the flavor stability of a fermented beverage produced from a fermentable medium. In this embodiment, the method comprises adding a composition comprising a tannin and a solid carrier to a fermentable medium prior to fermentation in an amount effective to stabilize flavor and thereafter fermenting the medium to prepare a fermented beverage having a stable flavor. In this method, the tannin can be a gallotannin, and the solid carrier can comprise at least one polyphenol. The solid carrier can comprise at least one of a solid hop residue and a malt. The solid hop residue can be obtained by extracting hops with carbon dioxide. The fermented beverage can be selected from the group consisting of beer, wine, sake, kefir, mead and spirits. The fermented beverage can be beer. In this method, the composition may be added to the fermentable medium in an amount ranging from about 1 to 1500 ppm by weight. In a further embodiment, the fermentable medium is malt and the composition is added to the malt before mashing of the malt. In another embodiment, the fermentable medium is wort and the composition is added to the wort before lautering of the wort. In yet another embodiment, the fermentable medium is wort and the composition is added to the wort before boiling of the wort.

In another aspect, the invention provides a method for improving a flavor stability of a fermented beverage produced from a fermentable medium. In this particular embodiment, the method comprises adding a pelletized solid hop residue to a fermentable medium prior to boiling the fermentable medium in an amount effective to stabilize flavor and thereafter fermenting the medium to prepare a fermented beverage having a stable flavor. The pelletized solid hop residue can comprise at least one polyphenol. The pelletized solid hop residue can be obtained by extracting hops with carbon dioxide. The fermented beverage can be selected from the group consisting of beer, wine, sake, kefir, mead and spirits. The fermented beverage can be beer. In the method, the fermentable medium can be malt and the pelletized solid hop residue can be added to the malt before mashing of the malt. In the method, the fermentable medium can be wort and the pelletized solid hop residue can be added to the wort before lautering of the wort. In the method, the fermentable medium can be wort and the pelletized solid hop residue can be added to the wort before boiling of the wort. In the method, the pelletized solid hop residue can be added to the fermentable medium in an amount ranging from about 1 to 1000 ppm by weight.

In another aspect, the invention provides a method for improving a flavor stability of a fermented beverage produced from a fermentable medium. In this embodiment, the method comprises adding a composition comprising a solid hop residue obtained by extracting hops with carbon dioxide to a fermentable medium prior to boiling the fermentable medium in an amount effective to stabilize flavor and thereafter fermenting the medium to prepare a fermented beverage having a stable flavor. In the method, the composition can further comprise a tannin. The tannin can be in the composition in a range from about 3 weight % to about 20 weight % of the composition. The solid hop residue can be in the composition in a range from about 80 weight % to about 97 weight % of the composition. The composition can further comprise water and have a moisture content ranging from about 1% to about 20%. The solid hop residue can comprise at least one polyphenol. In the method, the fermented beverage can be selected from the group consisting of beer, wine, sake, kefir, mead and spirits. The fermented beverage can be beer. In the method, the fermentable medium can be malt and the solid hop residue can be added to the malt before mashing of the malt. In the method, the fermentable medium can be wort and the solid hop residue can be added to the wort before lautering of the wort. In the method, the fermentable medium can be wort and the solid hop residue can be added to the wort before boiling of the wort. In the method, the solid hop residue can be added to the fermentable medium in an amount ranging from about 1 to 1000 ppm by weight.

In another aspect, the invention provides a method of producing a composition for improving the flavor stability of a fermented beverage produced from a fermentable medium. In this embodiment, the method comprises mixing a gallotannin powder and a plurality of solid carrier particles to create the mixture and pelletizing the mixture to produce the composition. The solid carrier particles can comprise at least one polyphenol. The solid carrier particles can comprise a solid hop residue obtained by extracting hops with carbon dioxide. The solid carrier particles can comprise a malt powder. The gallotannin powder can be in the composition in a range from about 3 weight % to about 20 weight % of the composition. The solid carrier particles can be in the composition in a range from about 80 weight % to about 97 weight % of the composition. The method can comprise mixing water with the gallotannin powder and the solid carrier particles wherein the water is mixed in an amount that yields a composition having a moisture content ranging from about 1% to about 20% after pelletizing. The method can comprise mixing at least one antioxidative ingredient with the gallotannin powder and the solid carrier particles. The at least one antioxidative ingredient can be selected from the group consisting of antiradical enzymes, antioxidative amino acids, chelating agents, malt polyphenol fractions, and mixtures thereof.

The invention has particular utility in the production of fermented malt beverages such as beer, although the invention also may be advantageously used in the production of other fermented beverages.

In one non-limiting example embodiment of the invention, a process is described for mixing dry gallotannin powder with spent hop powder and/or malt fines/flour and water to form a 3-to-20 minute, slow dissolving pellet. The flavor stability pellet is then added to the malt mash-in vessel at the very start of the incoming water for the hydration of the malt at the mash-in process or to the dry ground malt bill hopper, prior to malt mash-in. The initial 3-to-15 minute's segment of the malt mash-in process is a significant period for wort and beer oxidation and directly affects the flavor stability of the resulting packaged beer. The flavor stability pellet retards the harmful enzymatic and auto-oxidative lipoxygenase oxidation reactions at malt hydration in at least two ways: as a chelating agent, trapping the catalytic divalent cations that catalyze reactive oxygen species propagation, and as a reducing agent to quench already formed free radicals via hydrogen abstraction from hop polyphenol molecules.

The present invention addresses the long-felt needs discussed above and provides a reliable and improved method of stabilizing the flavor of fermented beverage, does not significantly alter the desirable fresh flavor of the finished product, does not significantly diminish the efficiency of the brewing process, and is not dependent on maintaining specific environmental conditions for the transportation and storage of the packaged product.

It is one advantage of the present invention to provide a composition comprising a tannin and a solid carrier that improves the flavor stability of the fermentable beverage added thereto.

It is another advantage of the present invention to provide a composition that improves the flavor stability and increases the shelf-life of a fermentable beverage applied thereto in a pellet form to improve safety, reduce handling and preparation costs, and generally improve a process used to produce a fermentable beverage.

It is another advantage of the present invention to provide a composition that reduces off-taste/aroma complaints in beer.

It is another advantage of the present invention to provide a composition that improves beer clarity by reducing chill haze turbidity.

It is another advantage of the present invention to provide a composition that reduces the amount of filtration aids (e.g., polyvinyl polypyrrolidone) required in the brewing process.

These and other features, aspects, and advantages of the present invention will become better understood upon consideration of the following detailed description, drawings, and appended claims.

### BRIEF DESCRIPTION OF DRAWINGS

FIG. 1 is a graph showing the relationship between a stale “papery” note of a lager-style beer and a length of time for a trial composition comprising a tannin, and a control sample.

FIG. 2 is a graph showing the relationship between a papery note of a lager-style beer and a length of time, measured over a plurality of weeks, for multiple trials comprising a tannin, and a control sample.

FIG. 3 is a graph showing the relationship between the flavor stability of a lager-style beer and a length of time for a trial composition comprising a tannin, and a control sample, wherein MCTS represents a taste system.

FIG. 4 is a graph showing the relationship between the flavor stability of a lager-style beer and a length of time for a trial composition comprising a solid carrier, and a control sample, wherein MCTS represents a taste system.

FIG. 5 is a graph showing the relationship between a papery, stale, and oxidized note of a lager-style beer and a length of time for a trial composition comprising a tannin and a solid carrier, and a control sample.

FIG. 6 is a graph showing the relationship between a papery, stale, and oxidized note of a lager-style beer and a length of time for a trial composition comprising a tannin and a solid carrier, and a control sample.

FIG. 7 is a graph showing the relationship between the flavor stability of a lager-style beer and a length of time for a trial composition comprising a tannin and a solid carrier, and a control sample, wherein MCTS represents a taste system.

FIG. 8 is a graph showing the relationship between a papery, stale, and oxidized note of a lager-style beer and a length of time for a trial composition comprising a gallotannin and a solid hop carrier, and a control sample.

FIG. 9 is a graph showing the relationship between a H₂S, mercaptan, sulphitic, and yeast roll up note of a lager-style beer and a length of time for a trial composition comprising a gallotannin and a solid hop carrier, and a control sample.

FIG. 10 is a graph showing the positive chelation of copper (Cu) and iron (Fe) when using a trial composition comprising a gallotannin and a solid hop carrier starting at the medium dosage rate and improving as the dosage is increased to a very high level.

### DETAILED DESCRIPTION OF THE INVENTION

This invention provides novel compositions and methods for stabilizing the flavor of a fermented beverage made from a fermentable medium by adding a composition comprising a tannin and a solid carrier to the fermentable medium prior to fermentation.

The term “about” or “approx.”, as used herein, refers to variation in the numerical quantity that may occur, for example, through typical measuring and liquid handling procedures used for making concentrates or solutions in the real world; through inadvertent error in these procedures; through differences in the manufacture, source, or purity of the ingredients used to make the compositions or carry out the methods; and the like. The term “about” may also encompass amounts that differ due to different equilibrium conditions for a composition resulting from a particular initial mixture. In one embodiment, the term “about” refers to a range of values +/−5% of a specified value.

The term “weight percent”, “wt. %”, “percent by weight”, “% by weight”, and variations thereof, as used herein, refer to the concentration of a substance as the weight of that substance divided by the total weight of the composition and multiplied by 100. It is understood that, as used here, “percent”, “%”, and the like may be synonymous with “weight percent”, “wt. %”, etc.

By “antioxidant” we mean a substance or nutrient capable of slowing or preventing the oxidation of other molecules. Oxidation is a chemical reaction that transfers electrons from a substance to an oxidizing agent. Oxidation reactions can produce free radicals, which start chain reactions that damage cells. When materials such as food or beverages are exposed to air, oxidative deterioration can occur. Oxidation can detrimentally affect the taste, color, and nutritional content of the food or beverage. To prevent this deterioration, compounds that prevent oxidation, antioxidants, are added to the food or beverage or are endogenous to the raw brewing ingredients. Antioxidants terminate these chain reactions by removing free radical intermediates, and inhibit other oxidation reactions by being oxidized themselves. Traditionally, the antioxidants are chemically synthesized. However, the possible toxicity of these compounds has stimulated the search for natural products like brewing ingredients with antioxidative properties. Similarly, a trend in the nutritional industry is to identify natural antioxidants.

In the methods of the present invention, the flavor of a fermented beverage is stabilized by adding a composition comprising a tannin and a solid carrier to a fermentable medium. By “stabilize” or “stabilizing”, we mean preserving the original, fresh flavor and character of the fermentable beverage during distribution and storage by reducing oxidation in the fermentable beverage.

By “fermented beverage” we mean any beverage produced by fermentation, including, but not limited to beer, wine, spirits, sake, cider, mead, kefir, yogurt and the like. By “beer” we mean any alcoholic beverage brewed from malt and hops, including but not limited to ales, stouts, lagers, porters, malt liquors, low-calorie, low-alcohol and light brews and the like.

By “fermentable medium” we mean any medium capable of being fermented to yield a fermented beverage. In one embodiment the fermentable medium is malt. By “malt” we mean any cereal grain, particularly barley, steeped in water until it is sprouted and used in brewing and distilling. However, in alternate embodiments, the fermentable medium is wort. By “wort”, we mean the liquor run-off after extracting a prepared solid material, such as a cereal grain or malt, with hot water.

The composition, as described herein, may be added to the fermentable medium at any time prior to fermentation. By “fermentation” we mean the conversion of carbohydrates to alcohols and carbon dioxide or organic acids using yeasts, bacteria, or a combination thereof, under anaerobic conditions. For instance, in one embodiment, the composition is added to the fermentable medium before fermentation or during mashing. By “mashing” we mean the brewing process where malt or grain is crushed and steeped in hot water to make wort. In alternate embodiments the composition is added to the fermentable medium before or during lautering. By “lautering” we mean the brewing process in which the mash is separated into the liquid wort and the solid residual grain. Lautering usually includes three steps: mashout, recirculation, and sparging. In another embodiment, the composition is added to the fermentable medium before or during sparging. By “sparging” we mean the brewing process where hot water is applied to the lautered grains to rinse out any remaining wort.

### Tannins

In one embodiment, the composition comprises a tannin. Tannin, or alternatively a tannic acid, may generally be characterized as a polyphenolic biomolecule. Tannins, as used herein, may be classified as a condensed tannin, a hydrolyzable tannin, or a phlorotannin. Condensed tannins are polymers with a flavanol structured monomer. Alternatively, a hydrolyzable tannin may be defined as an aromatic compound, e.g., a gallic acid or an ellagic acid, and a sugar, e.g., glucose, that have formed an ester bond. Phlorotannin may be defined as a compound that is an oligomer of phlorglucinol. Generally, tannins are capable of binding to and precipitating proteins and various other organic compounds including amino acids and alkaloids.

In one specific embodiment, a tannin is provided as a hydrolyzable tannin and, in the preferred embodiment, a hydrolyzable tannin that is a gallic acid ester formed from glucose and gallic acid. In this particular embodiment, the tannin may be gallotannin.

Tannins are to be used as an antioxidant and/or chelating agent for the fermentable medium applied thereto. Further, in the preferred embodiment, the tannin is in a solid form. Preferably, the tannin is provided as a powder or a pellet.

In one embodiment, the tannin is in the composition in a range from about 3 weight % to about 20 weight %, based on a total weight of the composition and, in another embodiment, in a range from about 3 weight % to about 12 weight %. In a non-limiting example embodiment, the tannin is in the composition in an amount of about 10 weight %, compared to the total weight of the composition.

### Solid Carrier

In one embodiment, the composition further comprises a solid carrier. A solid carrier, as used herein, may generally refer to solid material used in the composition. In a specific embodiment, the solid carrier comprises at least one of a hop residue and/or a solid hop residue. In the preferred embodiment, the solid carrier is a solid hop carrier obtained by extracting hops with carbon dioxide. In this specific embodiment, the hop residue may be a spent hop powder that may be a recycled product of a hop bitter resin and/or the result of a debittered hop powder. In another embodiment, the solid carrier comprises a malt, and in a particular embodiment, a malt powder.

The solid carrier may also preferably comprise at least one polyphenol. In some embodiments, the polyphenol is a flavonoid such as flavonol or quercetin. Further, the polyphenol may further be a dimer or a trimer polyphenol structure. In some embodiments, the dimer may be proanthocyanidin. In the preferred embodiment, the solid carrier may have antioxidative properties. For example, the solid carrier may be capable of being a chelating agent of divalent metal ions and/or capable of quenching reactive oxygen species and other free radicals through free radical hydrogen abstraction of the hydroxyl hydrogen.

In one embodiment, the solid carrier is in the composition in a range from about 80 weight % to about 97 weight % of the composition and, in another embodiment, in a range from about 88 weight % to about 97 weight %. In non-limiting example embodiments, the solid carrier is in the composition in an amount of about 90 weight %, or about 95 weight %, compared to the total weight of the composition.

### Water

The composition may further include water or a moisture content. In some embodiments, the composition comprises water and has a moisture content ranging from about 1% to about 20%. In some embodiments, the composition has a moisture content from about 8% to about 12%. In a non-limiting example embodiment, the composition has a moisture content of about 10%.

### Other Ingredients

The composition may also optionally include other ingredients and/or additives. For instance, in some embodiments, it may be desired to include antioxidative ingredients. Some preferred antioxidative ingredients may include antiradical enzymes like catalase and super oxide dismutase, antioxidative amino acids (e.g., tryptophan, leucine, alanine, glycine and cysteine), chelating agents, malt polyphenol fractions, and mixtures thereof.

The composition may be formed from a method comprising the steps of mixing a tannin powder and solid carrier particles to create a mixture and pelletizing the mixture to produce the composition. Before mixing, the tannin powder and/or the solid carrier may be dry, in a powder form, and have a moisture content ranging from about 0 to 15%. Preferably the moisture content is about 4%. In some embodiments, the solid carrier is first ground to a powder and the gallotannin is added and mixed in a predetermined amount. Then, water may be added to increase the moisture content to the desired level. If desired, the method may also include mixing at least one antioxidative ingredient with the gallotannin powder and the solid carrier particles. For example, antioxidative ingredients may include antiradical enzymes, antioxidative amino acids, chelating agents, malt polyphenol fractions, and mixtures thereof. After mixing, the hydrated powder may be pelletized into a pellet. The pellets may have a specific density, shape, size, texture, firmness, etc. After pelletizing, the pellets may then be weighted and vacuum packed into containers and stored until usage thereof.

During use, the containers, with the pellets therein, may be opened and the pellets poured into the desired container or a part of the process, such as a mash tun vessel at start of mash-in or later to the brew kettle.

In some embodiment, a mist of water is provided during the mixing of the tannin powder and the solid carrier particles. Further, pelletizing may be performed with a catalase and amino acids, such as non-Strecker amino acids. It may be desired to perform the aforementioned steps in order to prevent the formation of hydrogen peroxide or other undesired side products thereof during the production of the composition.

As previously discussed, in the preferred embodiments, the composition is in the form of a pellet. The pellets may be formed to be approximately 0.1 to 2 inches in length thereof. In a preferred embodiment, the pellets are approximately 1 inch in length. Further, the composition may be formulated so that the composition may be released in the fermentable medium at an effective rate of 8 minutes to 15 minutes.

The composition may be added to the fermentable medium in any amount effective to improve the flavor stability of the fermented beverage.

In one embodiment, a composition comprising a tannin and a solid carrier is added to the fermentable medium in an amount ranging from 1 to 1500 parts per million (ppm) by weight. In another embodiment, the composition is added to the fermentable medium in an amount ranging from 200 to 1200 ppm by weight. In another embodiment, the composition is added to the fermentable medium in an amount ranging from 200 to 600 ppm by weight. In non-limiting example embodiments, the composition is added to the fermentable medium in an amount of about 300 ppm by weight, or about 400 ppm by weight, or about 500 ppm by weight.

In one embodiment, a pelletized solid hop residue is added to a fermentable medium prior to boiling the fermentable medium in an amount effective to stabilize flavor. The pelletized solid hop residue may be added to the fermentable medium in an amount ranging from about 1 to 1000 ppm by weight. In another embodiment, the pelletized solid hop residue may be added to the fermentable medium in an amount ranging from in an amount ranging from 200 to 800 ppm by weight. In another embodiment, the pelletized solid hop residue may be added to the fermentable medium in an amount ranging from in an amount ranging from 400 to 600 ppm by weight.

In one embodiment, a composition comprising a solid hop residue obtained by extracting hops with carbon dioxide is added to a fermentable medium prior to boiling the fermentable medium in an amount effective to stabilize flavor. The solid hop residue can be added to the fermentable medium in an amount ranging from about 1 to 1000 ppm by weight. In another embodiment, the solid hop residue can be added to the fermentable medium in an amount ranging from in an amount ranging from 200 to 800 ppm by weight. In another embodiment, the solid hop residue can be added to the fermentable medium in an amount ranging from 400 to 600 ppm by weight.

The composition may be added to the fermentable medium at any time prior to, or during the early stages of, fermentation of the fermentable medium. In the preferred embodiments, the composition is added at the start of the malt mash-in process, before mashing of the malt, to the ground malt bill hopper, to the wort before lautering of the wort, before boiling of the wort and/or in the brew kettle during filling. The composition may be added to the fermentable medium prior to fermentation in an amount effective to stabilize the flavor.

### EXAMPLES

The following Examples are presented for purposes of illustration and not of limitation. Unless otherwise stated, all percentages recited in these examples are weight percentages based on the total specified composition weight. Further, as previously noted, the compositions, as disclosed herein, help improve the flavor stability and shelf life of the fermented beverage added thereto. As such, the following examples, and the experiments disclosed therein, provide comparative results showing such.

### Example 1. Tannin Properties

As discussed herein, tannins and, more preferably gallotannins and/or gallic acids, are chelating agents of divalent metals and work quickly in aqueous solutions. Analytical results of gallotannins or tannic acids, i.e., Tan'activ GTH or Brewtan B, are shown in Table 1.

TABLE 1

| | | Values | | |
|---|---|---|---|---|
| Characteristics | Unit | Tan'activ GTH | Brewtan B | Method |
| Appearance | | light hazelnut powder | light hazelnut powder | |
| Tannins | % | 95.4 | 94.7 | ISO 14088: 2012* |
| Tannins (dry) | % | 99.8 | 99.5 | ISO 14088: 2012* |
| Non Tannins | % | 0.2 | 0.5 | ISO 14088: 2012* |
| Insolubles | % | 0.0 | 0.0 | ISO 14088: 2012* |
| Water | % | 4.4 | 4.8 | ISO 14088: 2012* |
| T/nT Ratio | | 477.00 | 189.40 | ISO 14088: 2012* |
| pH (1%) | | 3.3 | 3.5 | TAN/04 |
| Ashes (dry) 550° C. | % | 0.05 | 0.09 | TAN/06 |
| Ethyl alcohol Solubility | | Pass Test | Pass Test | TAN/10 |
| Water Solubility | | Pass Test | Pass Test | TAN/10 |
| Gums & Dextrins | | Pass Test | Pass Test | TAN/13 |
| Resinous substances | | Pass Test | Pass Test | TAN/14 |
| Free Gallic Acid | | 0.41 | <0.04 | HPLC/GA2 |

### Example 2. Tannin Test

Methods and Materials. A gallotannin composition, i.e., Brewtan B as shown in Table 1, was added to the wort stream of a lager-style beer at mash-in at 26 ppm. A directional difference was determined if a measured p-value was 0.05 or less. Further, a significant difference was determined if a measured p-value was 0.06 to 0.15. Overall, a flavor stability test was determined as successful or non-successful. A sensory trial at 75° F. was performed, and a stale note was taken.

Results. Table 2 shows the flavor stability results of using a composition comprising a gallotannin. Significant flavor stability success was observed with the composition usage at mash-in for eight out of ten trials. The non-significant difference, i.e., NSD, in flavor stability trials only showed a directional improvement in less oxidized flavor of a p-value of 0.110 with high-sulfur or SO₂ contents. Further, Trial 11 showed a disappearance of upstream wort success that was due to high Fe diatomaceous earth (DE) filter material used for filtration. Even though the beer was metallic, the oxidized note was still a directional improvement with a p-value of greater than 0.050 even after nine months under heat treatment at 68° F. Trials 1 and 6 showed an ANOVA significant sensory flavor stability improvement and success in the reduction of the off-note “papery” after 16 weeks at 75° F., i.e., p-value=0.00. As seen in Trials 12a and 12b, an NSD at 8 weeks at 75° F. was observed, but a significant difference success was observed in the reduction of the sulphidic off-note, with a subsequent increase in Malty/Grainy in Trial 12b.

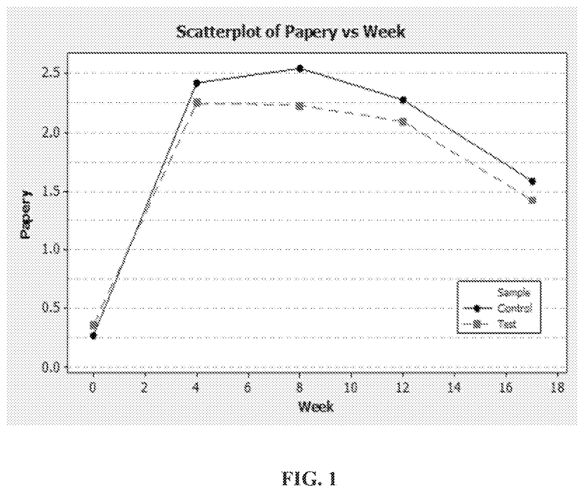

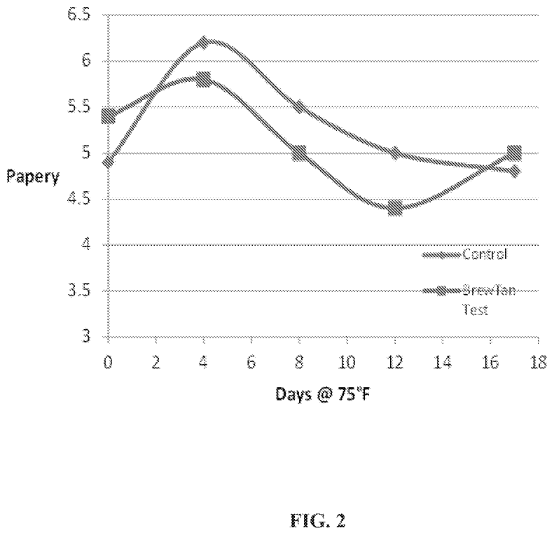

With reference to FIG. 1, the trans 2-nonenal (t2N) derived “papery” oxidized note was lower than a control in Trial 6. Similarly, in reference to FIG. 2, the t2N derived “papery” oxidized note, was tracked mostly at lower levels than a control in Trial 12a and 112b. Overall, the lager beer treated with the gallotannin composition showed significant improvements in flavor stability in ten out of twelve production trials with the reduction of stale, papery, oxidized, and sulphidic off-notes, especially in longer periods of forced aging treatments.

TABLE 2

| | | | Flavor | | | |
|---|---|---|---|---|---|---|
| | Directional | Significant | Stability | Sensory | Stale Note | |
| Trial | Difference | Difference | Success | Trial | Improvement | p-value |
| 1 | N/A | Yes | Yes | 8 weeks | Papery | 0.024 |
| | | | (8 weeks) | | | |
| 2 | N/A | Yes | Yes | 18 months | Stale | 0.053 |
| | | | (8 weeks) | Production | | |
| 3 | N/A | Yes | Yes | 18 months | Stale | 0.003 |
| | | | (8 weeks) | Production | | |
| 4 | N/A | Yes | Yes | 18 months | Stale | 0.001 |
| | | | (8 weeks) | Production | | |
| 5 | N/A | Yes | Yes | 18 months | Stale | 0.001 |
| | | | (8 weeks) | Production | | |
| 6 | Yes | Yes | Yes | ANOVA | Papery | 0.000 |
| | (2 months) | | (0-16 | Session | | |
| | | | weeks) | | | |
| 7 | Yes | Yes | Yes | 0, 3, 7 | Oxidized | 0.030 |
| | (6 months) | | (16 | weeks, 3, | | |
| | | | weeks) | 4, 5, 6 | | |
| | | | | months | | |
| 8 | Yes | Yes | Yes | 1, 2, 3, 4, | Oxidized | 0.040:0.040 |
| | (6 months) | | (8 and 20 | 5, and 6 | | |
| | | | weeks) | months | | |
| 9 | Yes | NSD | No | 8, 12, 16, | Oxidized | 0.110 |
| | (2 and 4 | | Difference | and 20 | | |
| | months) | | | weeks | | |
| 10 | Yes (4 | Yes | Yes | 8, 12, 16, | Oxidized | 0.020 |
| | months) | | (20 | 20 and 24 | | |
| | | | weeks) | weeks | | |
| 11 | No | NSD | No | 9 months | Oxidized | >0.050 |
| | | | Difference | | | |
| 12a | No | NSD | No | 8 weeks | No Difference | NSD |
| | | | Difference | | | |
| 12b | Yes | Yes | TBD | 17 weeks | Sulphidic, | 0.013; |
| | (4 and 8 | | | | Malty/Grny | 0.020 |
| | weeks) | | | | | |

Electron paramagnetic resonance (EPR), trans 2-nonenal (t2N), and thiobarbituric index (TBI) analytical results were determined for Trials 6, 11, 12a, and 12b. The results are shown in Table 3. Trial 6 showed beneficial reductions in EPR T150, i.e., the quantity of free-radicals metric, through the brewing process and in the packaged beer. Further, in this trial, lower EPR T150, longer lag time, i.e., quantity of antioxidants metric, lower Fe levels and lower total and free t2N, showed percent improvements of −40.2, 6.2, −38.5, −1.5, and −10.5, respectively.

Trial 11 showed beneficial wort flavor stability percentage improvements in the EPR Area, i.e., free radical metric, Fe reduction, and TBI reduction, i.e., lipid peroxidation metric. As previously mentioned, Trial 11 used a high Fe diatomaceous earth (DE) filter material, followed by a control which negated the upstream improvements and probably adversely affected the NSD, nine month flavor stability testing.

Trial 12 showed mixed results with a similar Fe increase after primary filtration with DE that remained higher than a control in aging and packaged beer. The increase in Fe seemed to affect the NSD, 8 weeks at 75° F. testing shown in Table 2, but not the significant reduction in sulphidic and an increase in grainy/sweet seen at 17 weeks at 75° F. However, the packaged beer trials did show improvements in EPR T150, total and free t2N, showing percent reductions of −8.8, −12.7, and −7.3, respectively. Without intending to be bound by theory, these results help support the theory that reactive oxygen species (ROS) and t2N free and bound papery notes arise at the start of malt mash-in from Fe catalyzed free radical lipid peroxidation.

TABLE 3

| | | | | Total | Free | | % T/C | | | Total | Free | |
|---|---|---|---|---|---|---|---|---|---|---|---|---|
| Trial 6 | EPR T150 | Lagtime | Fe | T2N | T2N | TBI | EPR T150 | Lagtime | Fe | T2N | T2N | TBI |
| 1stWort Control | 4355 | | | | | | | | | | | |
| 1stWort Trial | 3984 | | | | | | −12.5 | | | | | |
| KETTLE Full Control | 19716 | | | | | | | | | | | |
| KETTLE Full Trial | 13670 | | | | | | −30.7 | | | | | |
| Kettle KO Control | 21215 | | | | | | | | | | | |
| Kettle KO Trial | 16772 | | | | | | −20.9 | | | | | |
| Cool Wort Control | 26470 | | | | | | | | | | | |
| Cool Wort Trial | 23260 | | | | | | −12.1 | | | | | |
| EOF Control | 25369 | | | | | | | | | | | |
| EOF Trial | 20606 | | | | | | −18.8 | | | | | |
| Pkg Control | 31326 | 86.9 | 26 | 0.714 | 0.124 | | | | | | | |
| Pkg Trial | 18773 | 92.3 | 16 | 0.703 | 0.111 | | −40.1 | 6.2 | −38.5 | −1.5 | −10.5 | |
| Trial 11 | Area × 10⁵ | Lagtime | Fe | T2N | T2N | TBI | Area × 10⁵ | Lagtime | Fe | T2N | T2N | TBI |
| 1stWort Control | 4 | | 146 | | | 8.3 | | | | | | |
| 1stWort Trial | 4 | | 63 | | | 5.6 | 0.0 | | −56.7 | | | −32.5 |
| KETTLE Full Control | 29 | | 71 | | | 12.3 | | | | | | |
| KETTLE Full Trial | 19 | | 50 | | | 10.0 | −34.6 | | −30.0 | | | −18.7 |
| Kettle KO Control | 18 | | 53 | | | 16.3 | | | | | | |
| Kettle KO Trial | 15 | | 23 | | | 10.6 | −16.5 | | −57.4 | | | −35.0 |
| Cool Wort Control | 31 | | 64 | | | 20.9 | | | | | | |
| Cool Wort Trial | 22 | | 31 | | | 10.9 | −27.3 | | −51.4 | | | −47.8 |
| Pkg Control | | | 53 | | | | | | | | | |
| Pkg Trial | | | 73 | | | | | | 37.9 | | | |
| Trial 12 | EPR T150 | Lagtime | Fe | T2N | T2N | TBI | EPR T150 | Lagtime | Fe | T2N | T2N | TBI |
| Cool Wort Control | 93833 | | 211 | 0.409 | 0.165 | | | | | | | |
| Cool Wort Trial | 69672 | | 188 | 0.433 | 0.179 | | −25.7 | | −11.1 | 5.7 | 8.2 | |
| EOF Control | 29742 | 180.0 | 121 | 0.226 | 0.052 | | | | | | | |
| EOF Trial | 33780 | 114.0 | 97 | 0.225 | 0.048 | | 13.6 | −36.7 | −19.7 | −0.4 | −7.7 | |
| Aging Control | 60836 | 101.0 | 26 | 0.234 | 0.061 | | | | | | | |
| Aging Test | 76812 | 98.0 | 31 | 0.224 | 0.072 | | 26.3 | −3.0 | 17.7 | −4.3 | 18.0 | |
| Pkg Control | 62661 | 89 | 11 | 0.646 | 0.124 | | | | | | | |
| Pkg Trial | 57159 | 79 | 18 | 0.564 | 0.115 | | −8.8 | −11.2 | 63.6 | −12.7 | −7.3 | |

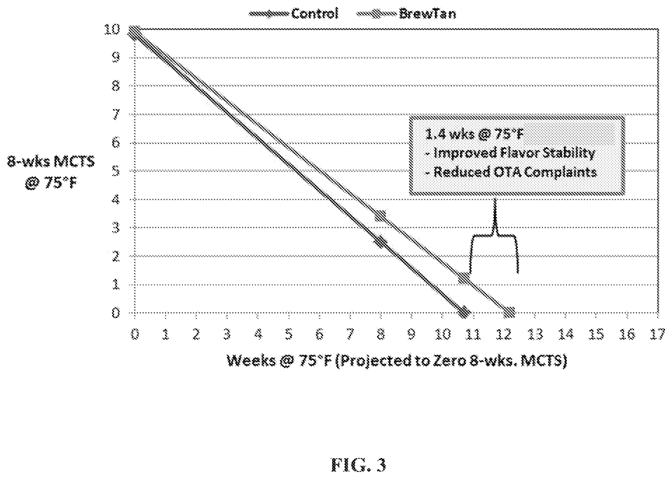

Analytical data was taken and is shown in Table 4 and FIG. 3 for Trials 6, 12a, and 12b. Stale aldehydes, i.e., heptanal, hexanal, and octanal, were reduced in the trials, compared to the control, by −3.8, −6.6, and −13.3 percent, respectively. There were reduced Off-Taste/Aroma (OTA) complaints. The fresh flavored alcohols and fruity esters increased in the trials, showing a more fresh tasting beer after warm storage for 17 weeks at 75° F. Overall, the packaged Fe was lowered by 7.1 percent in the trials. Further, lower Fe will help mitigate Fenton catalytic reactive oxygen reactions and the decrease in Fe in the packaged beer supports and shows the chelation ability of gallotannins.

The use of gallotannin also showed an ability of gallotannin to reduce haze-active proteins in mashing and brewing without adversely affecting the foam-enhancing proteins in the beer. As such, this should reduce the need for polyvinyl polypyrrolidone, i.e., PVPP, in beer production filtration costs.

TABLE 4

| | 6 | | 12 | | Control | Test | |
|---|---|---|---|---|---|---|---|
| Trial | Pkg Control | Pkg Trial | Pkg Control | Pkg Trial | Avg | Avg | % T/C |
| Heptanal ppb | 0.22 | 0.21 | 0.04 | 0.04 | 0.130 | 0.125 | −3.8 |
| Hexanal ppb | 1.39 | 1.27 | 0.27 | 0.28 | 0.830 | 0.775 | −6.6 |
| Octanal ppb | 0.39 | 0.33 | 0.06 | 0.06 | 0.225 | 0.195 | −13.3 |
| Polyphenols mg/L | 93.5 | 95.9 | 70.5 | 75.4 | 82 | 86 | 4.5 |
| Nibem 30 sec. | 166 | 159 | 142 | 154 | 154 | 157 | 1.6 |
| Total Esters mg/L | 29.5 | 31.9 | 20.7 | 21.4 | 25 | 27 | 6.2 |
| Total Vol mg/L | 110.4 | 114.9 | 86.5 | 90 | 98 | 102 | 4.1 |
| Amyl alcohol mg/L | 12.6 | 12.9 | 11.5 | 11.8 | 12.05 | 12.35 | 2.5 |
| Isoamyl alcohol mg/L | 40.8 | 41.7 | 32.1 | 33.7 | 36.45 | 37.70 | 3.4 |
| Isobutyl alcohol mg/L | 11.1 | 11.4 | 7.9 | 8 | 9.50 | 9.70 | 2.1 |
| Propanol mg/L | 7.7 | 8.6 | 6.5 | 6.7 | 7.10 | 7.65 | 7.7 |
| Ethyl acetate mg/L | 27.1 | 29.4 | 18.7 | 19.3 | 22.90 | 24.35 | 6.3 |
| Isoamyl acetate mg/L | 2.1 | 2.2 | 1.8 | 1.8 | 1.95 | 2.00 | 2.6 |
| Ethyl butyrate mg/L | 11.1 | 11.4 | 0.1 | 0.1 | 5.60 | 5.75 | 2.7 |
| Ethyl propanoate mg/L | 7.7 | 8.6 | 0 | 0.1 | 3.85 | 4.35 | 13.0 |
| Isopropyl acetate mg/L | 27.1 | 29.4 | 0 | 0 | 13.55 | 14.70 | 8.5 |
| Fe ppb | 25.6 | 16 | 11 | 18 | 18.3 | 17.0 | −7.1 |
| Total Forced EBC | 0.23 | 0.13 | 0.51 | 0.42 | 0.370 | 0.275 | −25.7 |
| Total Forced FTU | 16 | 9 | 35 | 29 | 26 | 19 | −25.5 |

### Example 3. Solid Carrier Test

Methods and Materials. Cone hops were ground into a fine powder to increase the efficiency of hop alpha, beta acids, hop oils, and total resin extraction by a liquid to super-critical CO₂ phase solvent. Once the hop bitter resins were removed, the resulting debittered hop powder was removed and collected. The debittered powder was repelletized into a hop pellet. Table A below (from Sharp, D.C., Vollmer, D. M., YangPing Qian, and Shellhammer, T. H., J. Am. Soc. Brew. Chem. 75(2):101-108, 2917) shows typical alpha acid and beta acid levels in spent hops after super-critical CO₂ extraction.

TABLE A
Spent Hop Bittering Acid Specifications^{a}

| | UV/visible | | HPLC | |
|---|---|---|---|---|
| Variety | Alpha % | Beta % | Alpha % | Beta % |
| Simcoe (2011)* | 0.2 | 0.4 | 0.2 | 0.7 |
| Cascade | 0.3 | 0.4 | 0.2 | 0.0 |
| Summit | 0.8 | 0.3 | 0.1 | 0.0 |
| Columbus (2011)* | 0.6 | 0.6 | 0.4 | 0.0 |
| Cluster | 0.8 | 0.4 | 0.4 | 0.2 |
| Horizon | 0.1 | 0.1 | 0.0 | 0.0 |
| Magnum | 1.2 | 0.4 | 1.0 | 0.2 |
| Nugget | 0.6 | 0.4 | 0.5 | 0.1 |
| Northern Brewer | 0.2 | 0.1 | 0.1 | 0.0 |
| Styrian Aurora | 0.1 | 0.2 | 0.1 | 0.0 |
| Nelson Sauvin | 0.0 | 0.3 | 0.1 | 0.0 |
| Hallertau Mittelfrüh | 0.2 | 0.2 | 0.1 | 0.0 |
| Willamette | 0.3 | 0.3 | 0.2 | 0.1 |
| Centennial (2011)* | −0.4 | 0.3 | 0.2 | 0.0 |
| German Spalt | 0.3 | 0.2 | 0.1 | 0.0 |
| Tettnanger | 0.3 | 0.1 | 0.1 | 0.0 |
| Hersbrucker | 0.2 | 0.1 | 0.0 | 0.0 |
| Perle | 1.0 | 0.2 | 0.6 | 0.2 |

^{a}Asterick (*) indicates industrial-scale supercritical fluid CO₂ extraction.

The hop pellet composition comprising a spent by-product of natural hop pellets and hop extract was added at 511 ppm to the malt mash-in vessel of a lager-style beer at the start of malt mash-in and at the same time as was done with the compositions in Example 2.

Results. With reference to Table 5, the trials that included the solid carrier were added to the malt mash-in and the brew kettle. The trials showed a significant improvement in the flavor stability and, in particular, in reducing the “papery” stale off flavor thereof.

TABLE 5

| | | | | | | | MVB | | MVB | | MVB | | MVB | |
|---|---|---|---|---|---|---|---|---|---|---|---|---|---|---|
| | Brewery: | | | | | | Test 1 | | Test 2 | | Test 3 | | Control | |
| | Sample ID: | | | | | | CDHMASHING | | CDHKETTLE | | CO2MASHING | | Control | |
| | Package Code: | | | | 8 WK ANOVA | | | Point | | Point | | Point | | Point |
| | Target | LTL | UTL | Weighting | F-value | p-value | Average | Loss | Average | Loss | Average | Loss | Average | Loss |
| Estery | 3 | 2.9 | 3.1 | 0.65 | | | 1.2 | 1.11 | 1.3 | 1.04 | 1.2 | 1.11 | 1.2 | 1.11 |
| Hoppy | 2 | 1.9 | 2.1 | 1.00 | | | 1.8 | 0.10 | 1.8 | 0.10 | 1.9 | | 1.7 | 0.20 |
| Stale | | 0.0 | 0.3 | 1.80 | | | 2.5 | 3.96 | 2.3 | 3.60 | 3.1 | 5.04 | 2.8 | 4.50 |
| Yeast Sulphurs | | 0.0 | 0.1 | 1.65 | | | 0.1 | | 0.0 | | 0.1 | | 0.3 | 0.33 |
| Non-Yeast Sulphurs | | 0.0 | 0.1 | 1.65 | | | 0.0 | | 0.0 | | 0.0 | | 0.0 | |
| Isoamyl Acetate | 2 | 1.9 | 2.1 | 0.35 | 1.23 | 0.32 | 0.6 | 0.46 | 0.8 | 0.39 | 0.6 | 0.46 | 0.6 | 0.46 |
| (Estery) | | | | | | | | | | | | | | |
| Ethyl Hexanoate | | 0.0 | 0.0 | 0.00 | 0.40 | 0.75 | 0.2 | | 0.1 | | 0.2 | | 0.2 | |
| (Estery) | | | | | | | | | | | | | | |
| Ethyl Acetate | | 0.0 | 0.0 | 0.00 | 0.00 | 1.00 | 0.4 | | 0.4 | | 0.4 | | 0.4 | |
| (Estery) | | | | | | | | | | | | | | |
| Kettle Hop | | 0.0 | 0.0 | 0.00 | 1.0 | 0.41 | 1.7 | | 1.7 | | 1.7 | | 1.6 | |
| (Hoppy) | | | | | | | | | | | | | | |
| Hop Oil | | 0.0 | 0.0 | 0.00 | 1.00 | 0.41 | 0.1 | | 0.1 | | 0.2 | | 0.1 | |
| (Hoppy) | | | | | | | | | | | | | | |
| Malty | 2 | 1.9 | 2.1 | 1.00 | 0.64 | 0.59 | 2.0 | | 1.9 | | 1.9 | | 2.0 | |
| Sour | 1 | 0.9 | 1.1 | 1.00 | 1.00 | 0.41 | 1.1 | | 1.0 | | 1.2 | 0.10 | 1.3 | 0.20 |
| Sweet | 2 | 1.9 | 2.1 | 1.00 | 1.33 | 0.29 | 2.0 | | 1.8 | 0.10 | 2.1 | | 1.8 | 0.10 |
| Bitter | 2 | 1.9 | 2.1 | 1.00 | 1.25 | 0.31 | 1.9 | | 2.1 | | 1.9 | | 2.0 | |
| Astringent | 1 | 0.9 | 1.1 | 1.00 | 1.80 | 0.17 | 1.4 | 0.30 | 1.7 | 0.60 | 1.5 | 0.40 | 1.3 | 0.20 |
| Body | 2 | 1.9 | 2.1 | 1.00 | 0.00 | 1.00 | 2.0 | | 2.0 | | 2.0 | | 2.0 | |
| Diacetyl | | 0.0 | 0.3 | 1.50 | 1.07 | 0.38 | 0.3 | | 0.1 | | 0.1 | | 0.0 | |
| H2S (Yeast | | 0.0 | 0.0 | 0.00 | 1.00 | 0.41 | 0.0 | | 0.0 | | 0.1 | | 0.2 | |
| Sulphurs) | | | | | | | | | | | | | | |
| Mercaptan | | 0.0 | 0.0 | 0.00 | 1.00 | 0.41 | 0.0 | | 0.0 | | 0.0 | | 0.1 | |
| (Yeast | | | | | | | | | | | | | | |
| Sulphurs) | | | | | | | | | | | | | | |
| Autolysed | | 0.0 | 0.0 | 0.00 | 1.00 | 0.41 | 0.1 | | 0.0 | | 0.0 | | 0.0 | |
| (Yeast | | | | | | | | | | | | | | |
| Sulphurs) | | | | | | | | | | | | | | |
| Oxidized (Stale) | | 0.0 | 0.0 | 0.00 | 0.50 | 0.68 | 1.6 | | 1.4 | | 1.6 | | 1.3 | |
| Papery (Stale) | | 0.0 | 0.0 | 0.00 | 2.97 | 0.05 | 0.9 | | 0.9 | | 1.5 | | 1.5 | |
| Metallic | | 0.0 | 0.5 | 1.30 | 1.98 | 0.14 | 0.3 | | 0.0 | | 0.0 | | 0.0 | |
| MCTS Score: | | | | | | | 4.07 | | 4.17 | | 2.89 | | 2.90 | |
| Total Point | | | | | | | | 5.9 | | 5.8 | | 7.1 | | 7.1 |
| Loss: | | | | | | | | | | | | | | |

TABLE 6

| | | | | | | | |
|---|---|---|---|---|---|---|---|
| | | % 32-wks | T-FSP vs. | % 56-wks | T-FSP vs. | Active | Active |
| State | Compound | At 75° F. | CR² | At 75° F. | CR² | Early | Late |

Free Stale Aldehydes

| | | | | | | | |
|---|---|---|---|---|---|---|---|
| FREE | 2-Furfural | −13.72% ^{I} | 0.9938 ^{I} | −15.93% ^{I} | 0.9866 ^{I} | *** ^{I} | ** ^{I} |
| FREE | Methional | −3.49% ^{I} | 0.9996 ^{I} | −0.91% | 0.8583 | *** ^{I} | NS |
| FREE | 5-Methyl furfural | −7.75% ^{I} | 0.9971 ^{I} | 0.02% | 0.6833 | *** ^{I} | NS |
| FREE | Phenylacetaldehyde | −9.56% ^{I} | 0.9961 ^{I} | −8.07% ^{I} | 0.9598 ^{I} | *** ^{I} | ** ^{I} |
| FREE | Pentanal | −1.24% ^{I} | 0.9952 ^{I} | −3.94% ^{I} | 0.9157 ^{I} | *** ^{I} | * ^{I} |
| FREE | Octanal | −4.38% ^{I} | 0.9788 ^{I} | −4.31% ^{I} | 0.9747 ^{I} | ** ^{I} | ** ^{I} |
| FREE | 3-Methyl butanal | −3.36% ^{I} | 0.9651 ^{I} | −2.64% ^{I} | 0.9616 ^{I} | ** ^{I} | ** ^{I} |
| FREE | Heptanal | −6.18% ^{I} | 0.9448 ^{I} | −5.59% ^{I} | 0.9010 ^{I} | * ^{I} | * ^{I} |
| FREE | E-2-Octenal | 10.36% | 0.8894 | −1.62% ^{I} | 0.9161 ^{I} | NS | * ^{I} |
| | Avg | −6.21% ^{I} | 0.9838 ^{I} | −5.21% ^{I} | 0.9140 ^{I} | ** ^{I} | * ^{I} |
| % | Free Stale Aldehydes | 36.1% | | 43.9% | | *** | >99% C.L. |
| % | Bound Stale Aldehydes | 63.9% | | 56.1% | | ** | >95% C.L. |

| | | |
|---|---|---|
| Green = Improvement (^{I}) | * | >90% C.L. |

| | |
|---|---|
| NS | Not |
| | Significant |

Total (Free & Bound) Stale Aldehydes

| | | | | | | | |
|---|---|---|---|---|---|---|---|
| TOTAL | Heptanal | −7.90% ^{I} | 1.0000 ^{I} | −9.43% ^{I} | 0.9678 ^{I} | *** ^{I} | ** ^{I} |
| TOTAL | Phenylacetaldehyde | −8.76% ^{I} | 0.9960 ^{I} | −7.72% | 0.7327 | *** ^{I} | NS |
| TOTAL | Benzaldehyde | −10.88% ^{I} | 0.9936 ^{I} | −11.66% ^{I} | 0.9817 ^{I} | *** ^{I} | ** ^{I} |
| TOTAL | E-2-Octenal | −8.40% ^{I} | 0.9908 ^{I} | −88.88% | 0.8483 | *** ^{I} | NS |
| TOTAL | Pentanal | −8.40% ^{I} | 0.9908 ^{I} | −10.96% | 0.8228 | *** ^{I} | NS |
| TOTAL | Octanal | −5.02% ^{I} | 0.9837 ^{I} | −6.34% | 0.8927 | ** ^{I} | NS |
| TOTAL | 5-Methyl furfural | −6.52% ^{I} | 0.9683 ^{I} | −6.44% ^{I} | 0.9716 ^{I} | ** ^{I} | ** ^{I} |
| TOTAL | Hexanal | −10.41% ^{I} | 0.9605 ^{I} | −11.69% ^{I} | 0.9029 ^{I} | ** ^{I} | * ^{I} |
| TOTAL | 2-Furfural | −16.62% ^{I} | 0.9548 ^{I} | −15.93% ^{I} | 0.9479 ^{I} | ** ^{I} | * ^{I} |
| TOTAL | E,Z-2,6-Nonadienal | −24.88% ^{I} | 0.9493 ^{I} | −23.21% ^{I} | 0.9571 ^{I} | * ^{I} | ** ^{I} |
| TOTAL | 2-Methyl butanal | −4.12% ^{I} | 0.9362 ^{I} | −4.70% ^{I} | 0.9334 ^{I} | * ^{I} | * ^{I} |
| | Avg | −17.22% ^{I} | 0.9749 ^{I} | −11.87% ^{I} | 0.9518 ^{I} | ** ^{I} | ** ^{I} |
| % | Free Stale Aldehydes | 36.1% | | 43.9% | | *** | >99% C.L. |
| % | Bound Stale Aldehydes | 63.9% | | 56.1% | | ** | >95% C.L. |

| | | |
|---|---|---|
| Green = Improvement (^{I}) | * | >90% C.L. |

| | |
|---|---|
| NS | Not |
| | Significant |

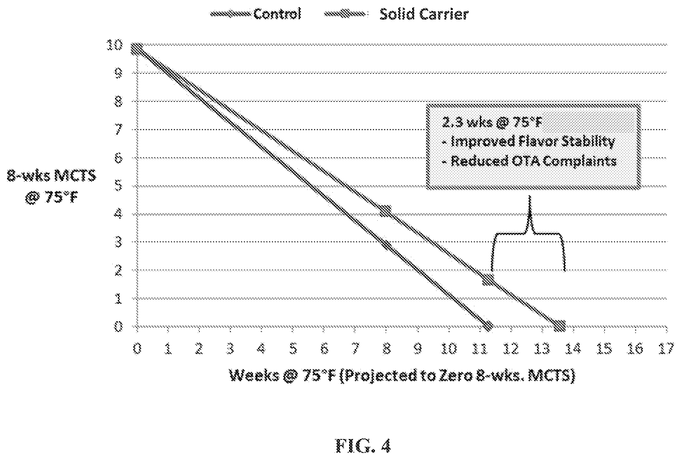

Overall, as shown in FIG. 4, the estimated improvement of the solid carrier added to the lager beer trials at the start of malt mash-in was 2.3 weeks of increased flavor stability, i.e., about 20.4%, over the control beer. There were reduced Off-Taste/Aroma (OTA) complaints.

### Example 4. Solid Hop Carrier Test 1

Methods and Materials. Testing was performed on ten brews of a lager-style beer. A solid hop carrier was added to the malt mash-in vessel in a dry pellet form at the start of malt mash-in, as the liquefied malt tangentially entered the malt mash-in vessel. The tests were compared to a control sample after a total of 26 weeks and at roughly 75° F. The comparative results were measured every two weeks. Further, a mean of the results for the ten brews was calculated.

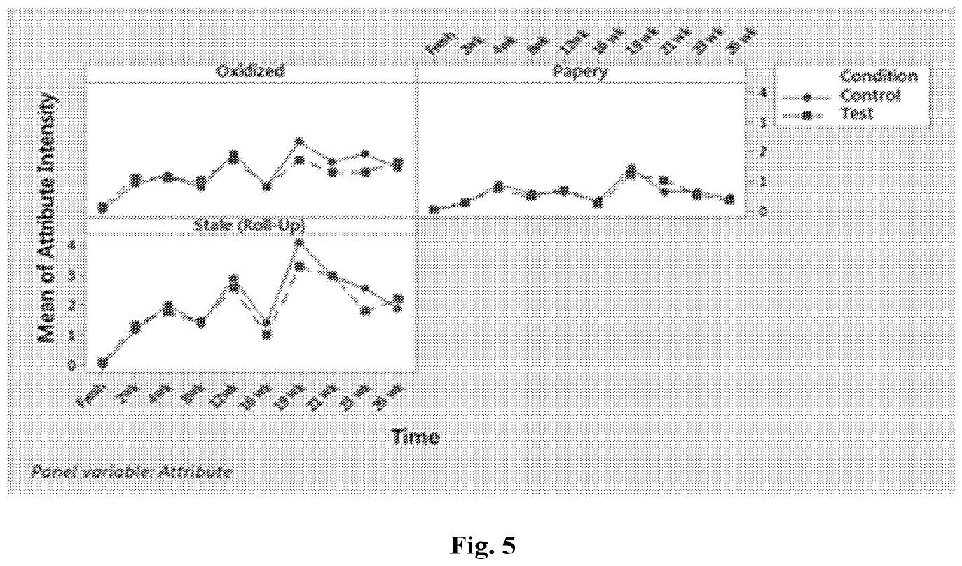

Results. As shown in FIG. 5, the lager-style beer test trials showed significant improvement in flavor stability by generally reducing the papery, oxidized, and stale off-notes in the test trials over the 26 week period.

### Example 5—Solid Hop Carrier Test 2

Methods and Materials. Testing was performed on six brews of a lager-style beer. A composition comprising a solid hop carrier was added to the malt mash-in vessel in a dry pellet form at the start of malt mash-in, as the liquefied malt tangentially entered the malt mash-in vessel. The tests were compared to a control sample after a total of four weeks and at roughly 75° F. A sensory evaluation was performed on the fresh brew and then subsequently every two weeks for a total of four weeks. The tests were carried out until the control and test trials diverged therefrom. Further, a mean of the results for the six brews was calculated.

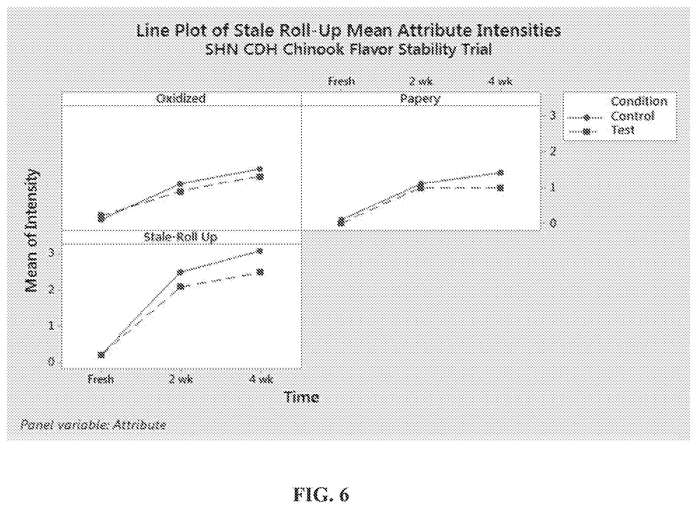

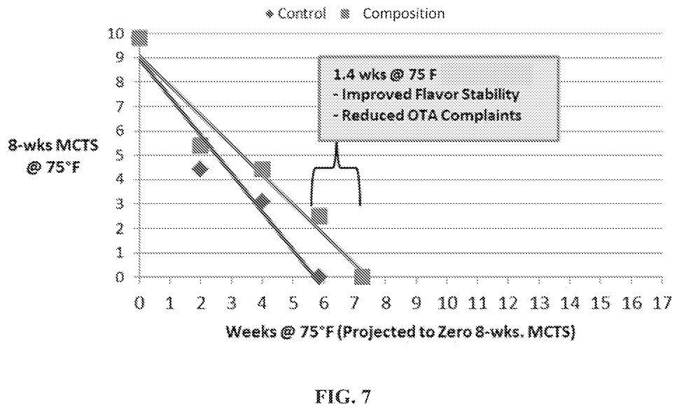

Results. As shown in FIGS. 6 and 7, the lager-style beer test trials showed significant improvement in flavor stability by reducing the “papery” and “stale-roll up” off-note in the beer, along with and improved the flavor stability of the fermented beverage by an increased 1.4 weeks. The trial, labeled as “SHN CDH Chinook” in FIG. 6 used Chinook hops in which the hop bitter resins were removed, and the resulting debittered hop powder was repelletized into a Choice Debittered Hops (CDH) pellet. In this trial, there were reduced Off-Taste/Aroma (OTA) complaints. See FIG. 7.

### Example 6—Gallotannin and Solid Hop Carrier Test

Methods and Materials. Testing was performed on 176 brews of a lager-style beer. A composition comprising gallotannin powder and a solid hop powder carrier in which the hop bitter resins were removed using super-critical CO₂ extraction was added at 537 ppm to the malt mash-in vessel in a dry pellet form at the start of malt mash-in, as the liquefied malt tangentially entered the malt mash-in vessel. The weight ratio of gallotannin powder to solid hop powder was 1:9. The tests were compared to a control sample after a total of 18 weeks and at roughly 75° F. The comparative results were measured every two weeks. Further, the composition outperformed the control beer showing reduced stale and sulphitic staling notes. Off Taste/Aroma (OTA) complaints were non-existent during this period.

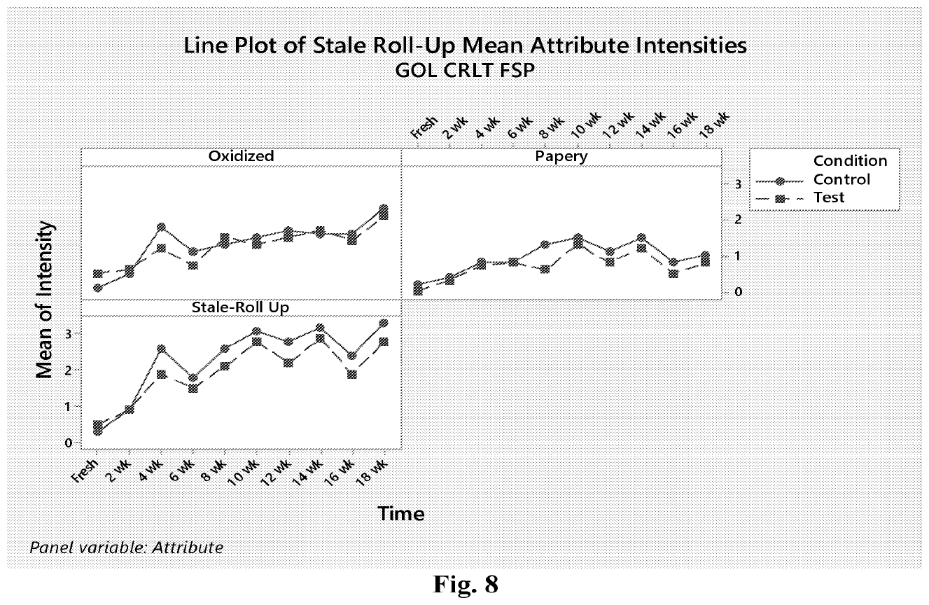

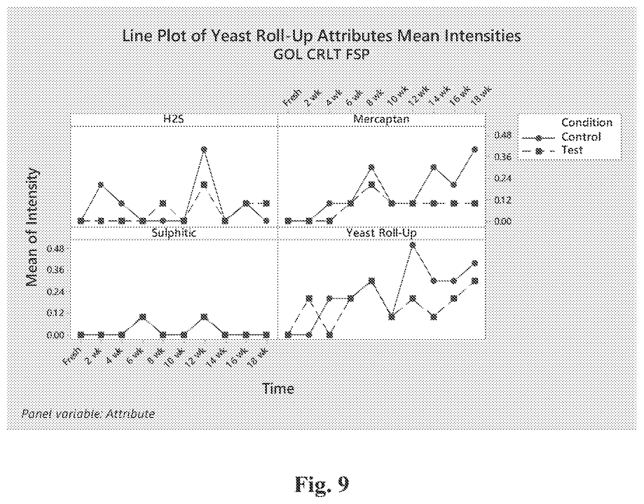

Results. As shown in FIGS. 8 and 9 (in which the trial is labeled as “GOL CRLT FSP”), the lager-style beer test trials showed significant improvement in flavor stability.

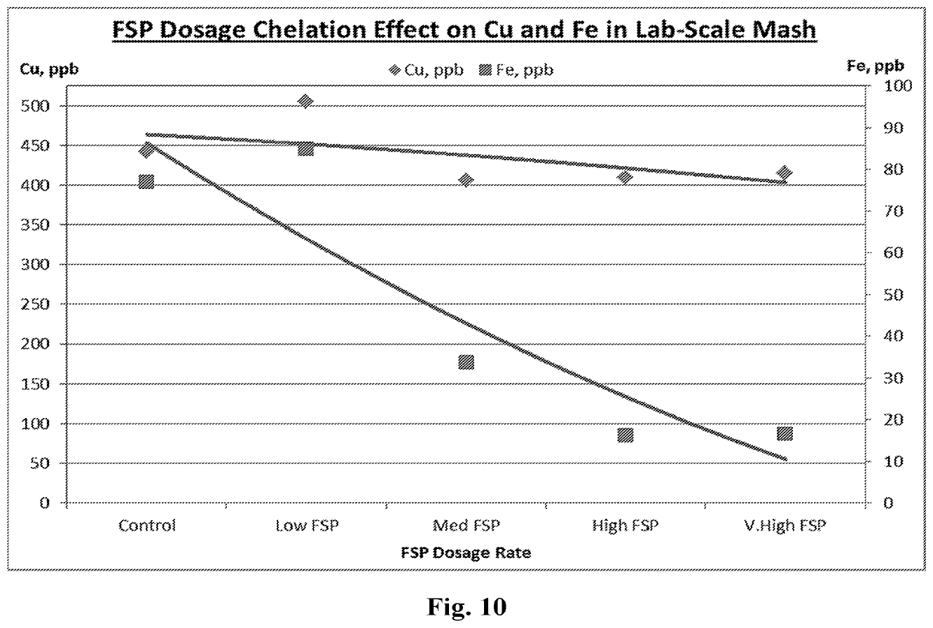

Results. As shown in Table 6, the usage of the flavor stability pellet comprising gallotannin powder and a solid hop powder carrier in which the hop bitter resins were removed using super-critical CO₂ extraction in mashing had a significant, positive impact in reducing the development of several off-taste stale aldehydes in the aged beer, both in the free-state and total (free+bound) state. In the trials of Table 6 and FIG. 10, the flavor stability pellet (FSP) had a weight ratio of gallotannin powder to solid hop powder of 1:20. The shift in the 32-weeks versus 56-weeks free:bound aldehyde ratio (36.1:63.9 versus 43.1:56.1, respectively) indicated that the bound stale aldehydes are still being released into a free state in packaged beer and the FSP test beer is still effective in showing improved reduction in staling at 56-weeks.

As shown in FIG. 10, lab-scale tests where FSP was dosed at various levels from: zero addition (control) to low (269 ppm FSP based on mash), medium (537 ppm FSP based on mash), high (805 ppm FSP based on mash), and very (v.) high levels (1073 ppm FSP based on mash) at the start of mashing. Samples were taken at the end of mashing and analyzed for Cu and Fe metals using an ICP metals method. The graph clearly shows the positive chelation of Cu and Fe levels starting at the medium dosage rate of FSP and improving as the dosage is increased to a very high level. With mitigation though chelation of divalent transition metals like copper and especially iron, the catalysis for reactive oxygen species (ROS) radical generation is also mitigated, which results in less aldehyde production and a more flavor stable beer.

### Summary of Examples 1-6

The CDH hop polyphenols appeared to retard the ROS staling reactions in the malt mash by both antioxidative hydrogen abstraction and transition metal chelation. Since a connection between sensory “papery” off-notes and the compound t-2-nonenal (t2N) in stale beer has been established, the antiradical activity of CDH is focused on the inactivation and retardation of lipoxygenase A and B (LOX). LOX levels in malt are known to promote stale precursor compounds through enzymatic and free radical oxidation of the unsaturated fatty acids (UFA) and the fact that the LOX enzyme needs Fe to function. The strong stale compound, t2N is a product of UFA oxidation. Thus, the extremely low papery levels in 26-week old beer stored at 75° F. strongly indicates that the antiradical activity of CDH hop polyphenols is due to a strong chelating capability to remove divalent metal catalysts, such as iron, copper and manganese, preventing t2N production from free radical oxidation of UFA.

The production of t2N and the precursors of other stale compounds are mitigated and the harmful LOX activity is denatured by these hop polyphenols. Its use in malt mashing, improves the known staling LOX effect by giving normal malt a low LOX activity quality.

The hop polyphenols and the gallotannin powders act as antioxidant utilizing both metal chelation and ROS quenching by hydrogen abstraction. When formed in a pellet using the appropriate amount of water to bind the pellet together, the pellet provides a slow release of the gallotannins and hop polyphenols by controlling the moisture %, pellet tightness and dispersion rate (e.g., 4-10% moisture, medium-crumbly tightness, dispersion rate in 65° C. H₂O of 8-15 minutes).

Thus, the invention provides compositions and methods for flavor stabilizing the flavor of a fermented beverage (e.g., beer) by the addition prior to, or during an early stage of, fermentation of a composition comprising a tannin and a solid carrier therein.

Although the invention has been described in considerable detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein.

1. A composition for improving a flavor stability of a fermented beverage produced from a fermentable medium, the composition comprising:
a tannin; and
a solid carrier,
wherein the composition is in a form of a pellet.

2. The composition of claim 1, wherein the tannin is a hydrolyzable tannin.

3. The composition of claim 2, wherein the hydrolyzable tannin is a gallotannin.

4. The composition of claim 3, wherein the gallotannin is a gallic acid ester formed from glucose and gallic acid.

5. The composition of claim 1, wherein the solid carrier comprises at least one polyphenol.

6. The composition of claim 1, wherein the solid carrier comprises a solid hop residue obtained by extracting hops with carbon dioxide.

7. The composition of claim 6, wherein the solid carrier comprises a malt powder.

8. The composition of claim 1, wherein the tannin is in the composition in a range from about 3 weight % to about 20 weight % of the composition.

9. The composition of claim 1, wherein the solid carrier is in the composition in a range from about 80 weight % to about 97 weight % of the composition.

10. The composition of claim 1, wherein the composition further comprises water and has a moisture content ranging from about 1% to about 20%.

11. (canceled)

12. The composition of claim 1, wherein the composition further comprises at least one antioxidative ingredient selected from the group consisting of antiradical enzymes, antioxidative amino acids, chelating agents, malt polyphenol fractions, and mixtures thereof.

13. The composition of claim 1, wherein:
the tannin is a gallotannin;
the solid carrier comprises a solid hop residue obtained by extracting hops with carbon dioxide;
the tannin is in the composition in a range from about 3 weight % to about 20 weight % of the composition; and
the solid carrier is in the composition in a range from about 80 weight % to about 97 weight % of the composition.

14. A method for improving a flavor stability of a fermented beverage produced from a fermentable medium, the method comprising:
adding a composition comprising a tannin and a solid carrier to a fermentable medium prior to fermentation in an amount effective to stabilize flavor; and
thereafter fermenting the medium to prepare a fermented beverage having a stable flavor.

15. The method of claim 14, wherein the tannin is a gallotannin.

16. (canceled)

17. The method of claim 14, wherein the solid carrier comprises at least one of a solid hop residue and a malt.

18. The method of claim 17, wherein the solid hop residue is obtained by extracting hops with carbon dioxide.

19. (canceled)

20. (canceled)

21. (canceled)

22. (canceled)

23. (canceled)

24. The method of claim 14, wherein the composition is added to the fermentable medium in an amount ranging from about 1 to 1500 ppm by weight.

25. A method for improving a flavor stability of a fermented beverage produced from a fermentable medium, the method comprising:
adding a pelletized solid hop residue to a fermentable medium prior to boiling the fermentable medium in an amount effective to stabilize flavor; and
thereafter fermenting the medium to prepare a fermented beverage having a stable flavor.

26. (canceled)

27. (canceled)

28. (canceled)

29. (canceled)

30. (canceled)

31. (canceled)

32. (canceled)

33. (canceled)

34. A method for improving a flavor stability of a fermented beverage produced from a fermentable medium, the method comprising:
adding a composition comprising a solid hop residue obtained by extracting hops with carbon dioxide to a fermentable medium prior to boiling the fermentable medium in an amount effective to stabilize flavor; and
thereafter fermenting the medium to prepare a fermented beverage having a stable flavor.

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. A method of producing a composition for improving a flavor stability of a fermented beverage produced from a fermentable medium, the method comprising:
mixing a gallotannin powder and a solid carrier particles to create a mixture; and
pelletizing the mixture to produce the composition.

47. (canceled)

48. (canceled)

49. (canceled)

50. (canceled)

51. (canceled)

52. (canceled)

53. (canceled)

54. (canceled)
